(19) United States
(12) Patent Application Publication
(10) Pub. No.: US 2016/0140481 A1
(43) Pub. Date: May 19, 2016

(54) TASK SUPERVISING SYSTEM AND METHOD THEREOF

(71) Applicant: INSTITUTE FOR INFORMATION INDUSTRY, TAIPEI CITY (TW)

(72) Inventors: PO-CHENG HUANG, Yunlin County (TW); YING-HSU CHEN, Kaohsiung City (TW); YUNG-HSING PENG, Kaohsiung City (TW); CHIN-SHUN HSU, Kaohsiung City (TW)

(21) Appl. No.: 14/563,627

(22) Filed: Dec. 8, 2014

(30) Foreign Application Priority Data
Nov. 14, 2014 (TW) 103139614

(51) Int. Cl. G06Q 10/06; G06F 17/30; G06Q 10/10

(52) U.S. Cl. CPC G06Q 10/063114; G06Q 10/103; G06Q 10/1097; G06Q 10/06313; G06F 17/30864; G06F 17/30241

(57) ABSTRACT

Disclosed are a task supervising system and a method thereof, for automatically reporting whether a task is fulfilled. The system generates a task list via a task generating module. A worker learn the task and a required task area of a task location via the task list transmitted. The worker uses a location acquiring unit to obtain a location information of an electric device, and at least a sensor to obtain a sensing signal. A task executing module would first determine whether the location information of an electric device is within the required task area of the task location. If yes, the sensing signal would be transmitted to a database storing a reference signal corresponding to the task in advance. Finally, via the database, a task supervising module compares the sensing signal and the reference signal so as to generate a supervised result corresponding to the task.

### FIELD

The instant disclosure relates to a task supervising system and a method thereof, and more particularly, for a task supervising system and a method thereof used to automatically report whether a task is fulfilled.

### BACKGROUND

For managers in different kinds of industries, task supervising is quite important regarding to leading and instructing workers. Take the agriculture for example, in order to accurately calculate the profits, the farmland manager needs to control the farming resource, the financial cost and the human resources. Also, the farmland manager needs to supervise the crop planting process to make sure a successful harvest for marketing. Therefore, it becomes necessary to build a system that manager tasks to the farmers and works with a great task supervising system.

Generally speaking, the farmers (or labors in other industries) are not good at operating electric devices and the operation interface thereof. Thus, so far the task supervising is often executed via recording the executed task by farmers' hand-writing. However, hand-writing provides little help for the farmland manager to efficiently supervise the whole task execution and to generate a record. In some situations, the task supervising may be recorded by hand-writing first and then recorded via a program interface. Nevertheless, it is merely an indirect recording, which refers to lower reliability, more time consumption and more manual works. On the other hand, the current execution for the task supervising is merely based on what has been recorded, but it would be hard to examine whether the record is true and whether the tasks in the record are indeed fulfilled.

Therefore, if the executed tasks and the information about the executed tasks (including the work duration, work location, the work traces and the like) can be automatically collected and the task supervising can be executed based on these collected information, it can efficiently increase the task supervising efficiency and also bring lots of convenience to the farmland manager and the farmers. Moreover, it can be examined whether the assigned tasks are indeed fulfilled according to the above automatically collected work information.

### SUMMARY

The disclosed embodiments include a task supervising system used to automatically report whether a task is fulfilled. The task supervising system comprises a task supervising module, a task processing module and a task supervising module. The task supervising module generates a task list corresponding to a task location, wherein the task list comprises a required task area for each specified task. The task processing module transmits the task list to an electric device, wherein the electric device has a task executing module to receive the task list provided to a worker for choosing a task from the task list (such as a first task), a location acquiring unit to obtain a location information of the electric device and at least one sensor to obtain at least one sensing signal. The task executing module further determines whether the location information of the electric device fulfills the required task area of the first task. If yes, at least one obtained sensing signal is transmitted to a database. The database stores a first reference signal corresponding to the first task and at least one sensing signal transmitted by the electric device corresponding to the first task. The task supervising module is connected to the database and configured to compare the sensing signal and the first reference signal corresponding to the first task so as to generate a supervised result corresponding to the first task.

The instant disclosure also provides a task supervising method, used to automatically report whether a task is fulfilled via a task supervising system. The task supervising system comprises a task supervising system, a task processing module and a task supervising module. The task processing module transmits the task list to an electric device. The electric device has a task executing module, a location acquiring unit and at least one sensor. The task supervising method comprises: generating a task list corresponding to a task location, wherein the task list comprises a required task area for each specified task via the task supervising module; receiving the task list provided to a worker for choosing a task from the task list via the task executing module, such as a first task; obtaining a location information of the electric device via the location acquiring unit; obtaining at least one sensing signal via the sensor; determining whether the location information of the electric device fulfills the required task area of the first task via the task executing module, if yes, transmitting at least one obtained sensing signal to a database, and storing a first reference signal corresponding to the first task and at least one sensing signal transmitted by the electric device corresponding to the first task to the database; and comparing the sensing signal and the first reference signal corresponding to the first task via the task supervising module connected to the database so as to generate a supervised result corresponding to the first task.

To sum up, via the task supervising system and the method thereof provided by the instant disclosure, tasks are generated by an administrator and the location information of the electric device and sensing signals are generated by a worker. After that, the location information of the electric device and the required task area are compared, and the sensing signals and the reference signals in the database are further compared, so as to generate a supervised result. Thereby, it becomes convenient for the administrator to supervise whether the worker actually fulfills tasks according to the given instructions and also to see whether the worker acts as expected.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a task supervising system according to an embodiment of the instant disclosure;

FIG. 2 shows a schematic diagram for showing how to determine whether the location information of the electric device is satisfied with the required task area according to an embodiment of the instant disclosure;

FIG. 3 shows a schematic diagram for comparing the sensing signals to generate a supervised result according to an embodiment of the instant disclosure;

FIG. 4 shows a block diagram of a task supervising system according to another embodiment of the instant disclosure;

FIG. 5 shows a schematic diagram for comparing the sensing signals and the device trajectory signal to generate a supervised result according to an embodiment of the instant disclosure;

FIG. 6 shows a block diagram of a task supervising system according to another embodiment of the instant disclosure;

FIG. 7 shows a flow chart of a task supervising method according to an embodiment of the instant disclosure;

FIG. 8 shows a flow chart of a task supervising method according to another embodiment of the instant disclosure; and

FIG. 9 shows a flow chart of a task supervising method according to an embodiment of the instant disclosure.

### DETAILED DESCRIPTION OF EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. The following description is going to illustrate a task supervising system and a method thereof provided by the instant disclosure with figures; however, it is not restricted by the embodiments below.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

[One Embodiment of the Task Supervising System]

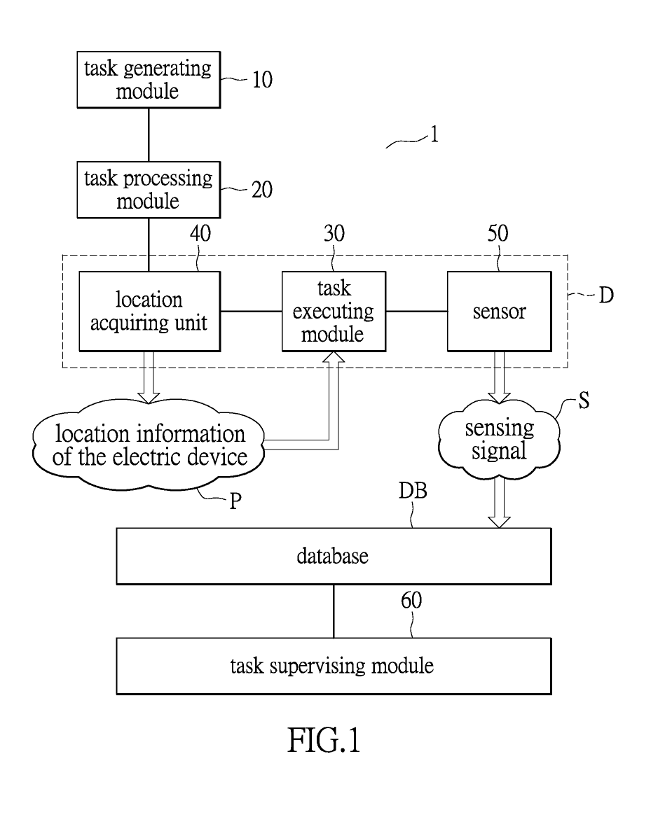

Please refer to FIG. 1. FIG. 1 shows a block diagram of a task supervising system according to an embodiment of the instant disclosure.

As shown in FIG. 1, the task supervising system 1 used to automatically report whether a task is fulfilled comprises a task generating module 10, a task processing module 20, a task executing module 30, a location acquiring unit 40, a sensor 50 and a task supervising module 60.

Regarding to the task generating module 10, the task generating module 10 is configured to generate a task list corresponding to a task location, wherein the task list comprises a first task and the first task has a required task area corresponding to the task location.

Regarding to the task processing module 20, the task executing module 30, the location acquiring unit 40 and the sensor 50, the task processing module 20 is configured to transmit the task list to the electric device D, wherein the electric device D has the task executing module 30, the location acquiring unit 40 and at least one sensor 50. The task executing module 30 is configured to receive the task list for the worker to choose a task therein, such as a first task. The location acquiring unit 40 is configured to obtain the location information of the electric device P, and the sensor 50 is configured to obtain a sensing signal S. Moreover, the task executing module 30 is further configured to determine whether the location information of the electric device P is satisfied with the required task area of the first task. If yes, the task executing module 30 transmits the obtained sensing signal S to the database DB. The database DB stores a first reference signal corresponding to the first task and the sensing signal transmitted by the electric device D corresponding to the first task.

Regarding to the task supervising module 60, the task supervising module 60 is connected to the database DB, configured to compare the sensing signal S and the first reference signal corresponding to the first task so as to generate a supervised result corresponding to the first task.

There is a further instruction in teaching an operation mechanism of the task supervising system 1 used to automatically report whether a task is fulfilled.

In one embodiment taking farmland management for example, the farmland manager generates a task list corresponding to his farmland via the task generating module 10, wherein the task list comprises a first task, such as fertilizing. The task list may also comprise other tasks, and the first task has a required task area assigned by the farmland manager.

After that, the task processing module 20 transmits the task list assigned by the manager to the electric device D, wherein the electric device D has a task executing module 30, a location acquiring unit 40 and at least one sensor 50. The farmer receives the task list via the task executing module 30 of the electric device D and chooses the first task in the task list. The first task has a required task area assigned by the manager. In other words, after the farmer chooses the first task, he would get the information from the manager for executing the first task at the required task area, such as fertilizing.

During executing the first task, the location acquiring unit 40 of the electric device D obtains the location information of the electric device P and the sensor 50 of the electric device D obtains a sensing signal. In one embodiment, the location acquiring unit 40 may be a GPS device, and the location information of the electric device P may be a GPS signal. In other embodiments, the location acquiring unit 40 may also be a device with mobile radio cellular positioning, location based service for long term evolution, mobile network positioning, Wi-Fi positioning, iBeacons or the like. Additionally, the sensor 50 may be a gravity sensor, and the sensing signal S generated by the gravity sensor would have different signal features according to different tasks. In other words, for the same gravity sensor, one signal feature corresponds to one task. However, types of the location acquiring unit 40 and the sensor 50 of the electric device D are not limited herein.

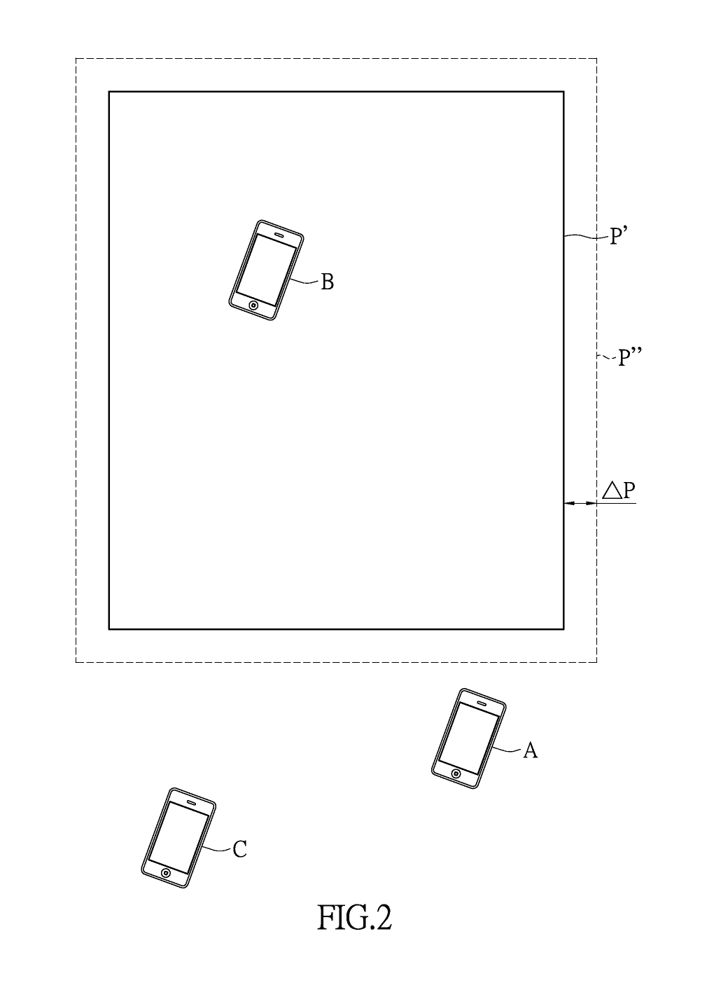

Please refer to FIG. 2, FIG. 2 shows a schematic diagram for showing how to determine whether the location information of the electric device is satisfied with the required task area according to an embodiment of the instant disclosure.

In this embodiment, the task executing module 30 determines whether the location information of the electric device P is satisfied with the required task area corresponding to the first task when the farmer executes the first task. If yes, the task executing module transmits the obtained sensing signal S to the database DB.

Further, as shown in FIG. 2, the task executing module 30 adds a soft margin ΔP to the required task area P′ to generate an updated required task area P″ corresponding to the first task before determining whether the location information of the electric device P is satisfied with the required task area P′ corresponding to the first task. In details, when the electric device D starts to enter into the updated required task area P″ (at this moment, the position of the electric device D is shown as the position A in FIG. 2, and the position A is where the electric device D starts to enter into the updated required task area P″), the task executing module determines that the location information of the electric device P is satisfied with the required task area P′. As a result, the task executing module 30 starts to transmit the generated sensing signal S to the database DB for storage (at this moment, the position of the electric device D is shown as the position B in FIG. 2, and the position B is where the electric device D has entered into the updated required task area P″). Finally, when the first task is finished and the electric device D starts to leave the updated required task area P″ (at this moment, the position of the electric device D is shown as the position C in FIG. 2, and the position C is where the electric device D starts to leave the updated required task area P″), the task executing module 30 determines that the location information of the electric device P is not satisfied with the required task area P′. As a result, the task executing module 30 stops transmitting the sensing signal S to the database DB. The sensing signal S transmitted to the database DB corresponding to the first task and the first reference signal corresponding to the first task are stored in the database DB in advance.

After the sensing signal S generated by the sensor 50 is transmitted to the database DB, the task supervising module 60 compares the sensing signal S corresponding to the first task and the first reference signal so as to generate a supervised result corresponding to the first task. Thereby, the farmland manager can supervise instantly whether the farmer executes the first task as the assigned task list.

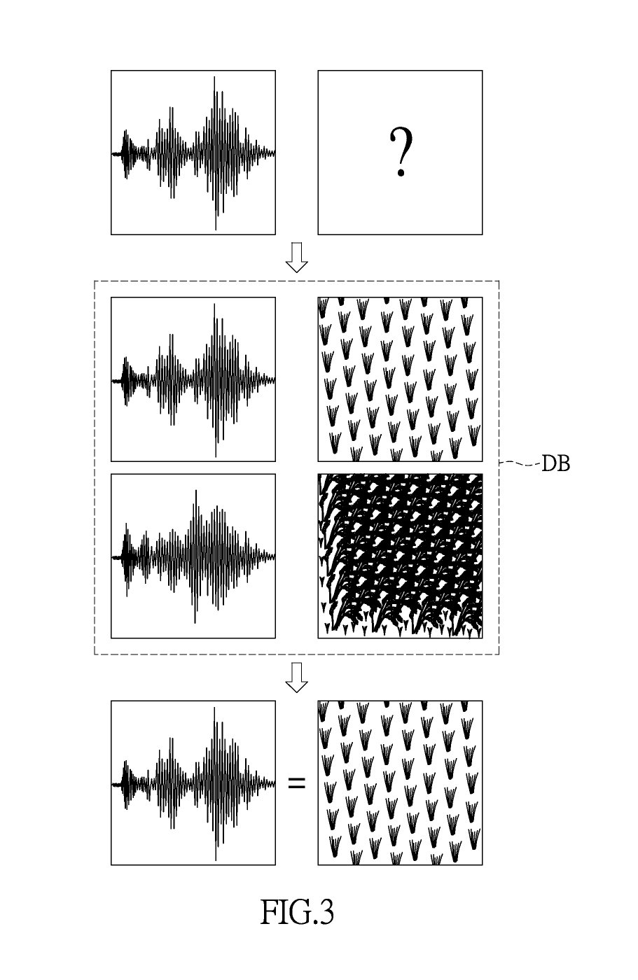

Please refer to FIG. 3, FIG. 3 shows a schematic diagram for comparing the sensing signals to generate a supervised result according to an embodiment of the instant disclosure. As disclosed in the above embodiment, the sensor 50 may be a gravity sensor (used to sense the speed and displacement of the electric device), a humidity sensor to determine whether to water and to have a chemical spray, a spectrum signature sensor to determine whether there are other plants nearby, an electric compass to sense the change rate of farmer's orientation or the like and it is not limited thereto. Take the gravity sensor for example, according to different tasks, the sensing signal S generated by the gravity sensor would have different signal features. In other words, for the same gravity sensor, one signal feature corresponds to one task executed by the farmer. As shown in FIG. 3, the task supervising module 60 compares and finds out the first reference signal corresponding to the first task according to the signal feature included in the sensing signal S generated by the gravity sensor via the database DB. Thereby, the task supervising system in the instant disclosure helps the farmland manager to automatically supervise whether the executed task is the first task via the sensing signal S generated by the gravity sensor.

Additionally, in this embodiment, the task supervising module 60 compares whether the sensing signal S is satisfied with the first reference signal corresponding to the first task based on calculating and determining whether a relevance between the sensing signal S and the first reference signal is over a predetermined value. If the calculated relevance is under the predetermined value, the task supervising module 60 determines that the sensing signal S is not satisfied with the first reference signal corresponding to the first task.

It should be noted that, in one embodiment, the work duration may be rather long and the reference signal may remain the same or similar, and thus it needs not to have a continual sensing and comparing. When the task executing module 30 determines that the location information of the electric device P is satisfied with the required task area P′, it starts to transmit the sensing signal S generated by the sensor 50 to the database DB for storage. The task executing module 30 transmits the sensing signal S to the database for storage with a predetermined time interval, but not continually transmits the sensing signal S to the database DB, so as to save power for the electric device.

In one embodiment, the task list received by the task executing module 30 of the electric device D may also comprise a plurality of tasks (such as a first task and a second task), and the farmer can choose the first task or the second task from the task list wherein the first task and the second task respectively have the required task areas assigned by the manager. In other words, after the farmer chooses the first task and he would get the information from the manager for executing the first task at the required task area, such as fertilizing. Or, if the farmer chooses the second task and he would get the information from the manager for executing the second task at the required task area, such as weeding. It should be noted that, the operation mechanism for supervising the second task is similar as the operation mechanism for supervising the first task which is recited above, and thus it is not repeated thereto.

It should be noted that, the task supervising system 1 in this embodiment may be applied to agriculture, fishery, livestock industry, mining, forestry or construction industry, so as to help the manager to automatically supervise whether the task executed by the worker is satisfied with the task in the assigned task list.

[Another Embodiment of the Task Supervising System]

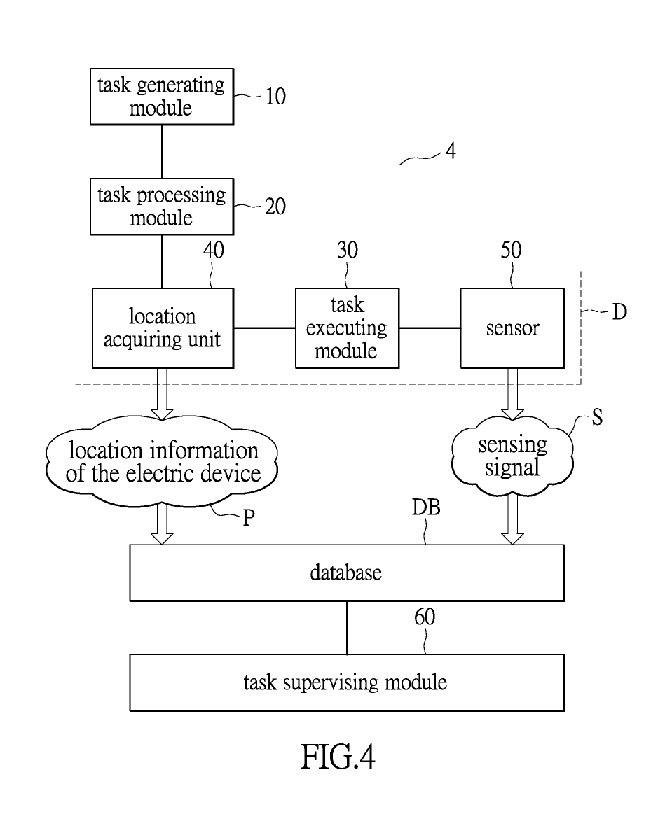

Please refer to FIG. 4, FIG. 4 shows a block diagram of a task supervising system according to another embodiment of the instant disclosure.

Different form the embodiment in FIG. 1, in this embodiment, when the task executing module 30 determines that the location information of the electric device P is satisfied with the required task area, it would transmit the location information of the electric device P to the database DB for storage at the same time. It should be noted that, the database DB stores the first trajectory reference signal corresponding to the first task in advance.

There is a further instruction in teaching an operation mechanism of the task supervising system 3 used to automatically report whether a task is fulfilled.

In this embodiment, when the farmer executes the first task, the task executing module 30 would determine whether the location information of the electric device P is satisfied with the required task area. If yes, the task executing module 30 transmits the received sensing signal S to the database DB. At the same time, the task executing module 30 would also transmit the location information of the electric device P to the database DB for storage.

Further, as shown in FIG. 2, the task executing module 30 adds a soft margin ΔP to the required task area P′ to generate an updated required task area P″ corresponding to the first task before determining whether the location information of the electric device P is satisfied with the required task area P′ corresponding to the first task. In details, when the electric device D starts to enter into the updated required task area P″ (at this moment, the position of the electric device D is shown as the position A in FIG. 2; the position A is where the electric device D starts to enter into the updated required task area P″), the task executing module 30 determines that the location information of the electric device P is satisfied with the required task area P′. As a result, the task executing module 30 starts to transmit the generated sensing signal S to the database for storage, and also the task executing module 30 starts continually or with a predetermined time interval to transmit the location information of the electric device P to the database DB for storage (at this moment, the position of the electric device D is shown as the position B in FIG. 2, and the position B is where the electric device D has entered into the updated required task area P″). Finally, when the first task is finished and the electric device D starts to leave the updated required task area P″ (at this moment, the position of the electric device D is shown as the position C in FIG. 2, and the position C is where the electric device D starts to leave the updated required task area P″), the task executing module 30 determines that the location information of the electric device P is not satisfied with the required task area P′. As a result, the task executing module 30 stops transmitting the sensing signal S generated by the sensor 50 and the location information of the electric device P generated by the location acquiring unit 40 to the database DB. The sensing signal S transmitted to the database DB corresponds to the first task is store in the database DB. Also, the first reference signal corresponding to the first task and the first trajectory reference signal corresponding to the first task are stored in the database DB in advance.

After sensing signal generated by the sensor 50 is transmitted to the database DB, the task supervising module 60 compares the sensing signal S and the first reference signal corresponding to the first task. On the other hand, after the location information of the electric device P generated by the location acquiring unit 40 is transmitted to the database DB, the task supervising module 60 generates a device trajectory signal based on the accumulated and stored location information of the electric device P corresponding to the first task and compares the device trajectory signal and the first trajectory reference signal. The task supervising module 60 generates a supervised result corresponding to the first task via comparing the sensing signal S and the first reference signal corresponding to the first task and via comparing the device trajectory signal and the first trajectory reference signal. Thereby, the farmland manager can supervise instantly whether the farmer executes the first task according to the assigned task list.

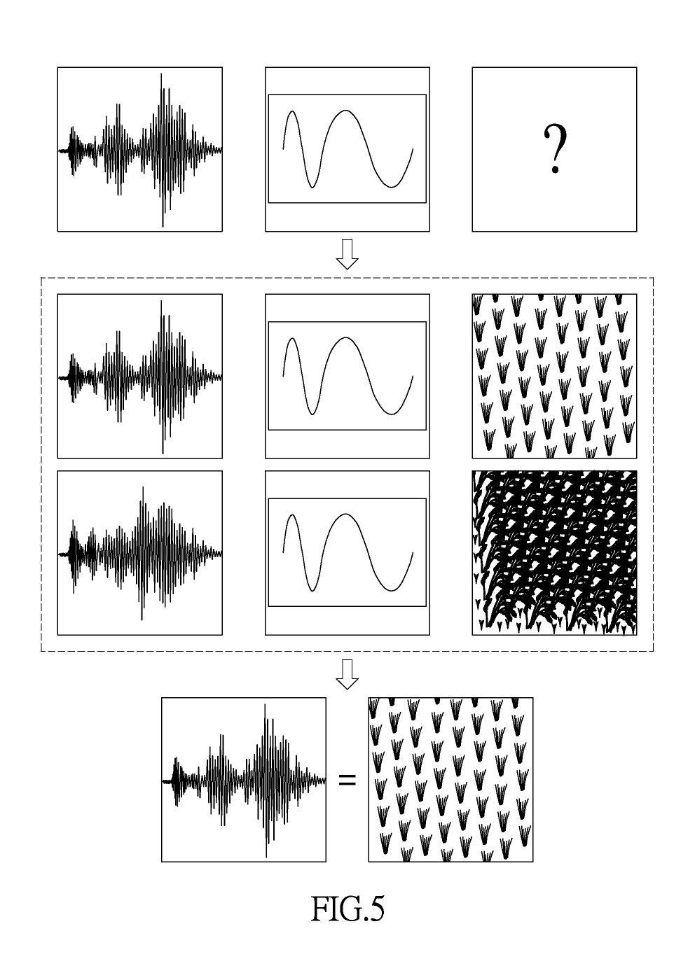

Please refer to FIG. 5, FIG. 5 shows a schematic diagram for comparing the sensing signals and the device trajectory signal to generate a supervised result according to an embodiment of the instant disclosure. In this embodiment, the sensor 50 may be a gravity sensor. According to different tasks, the sensing signals S generated by the gravity sensor may have different signal features. In other words, for the same gravity sensor, one signal feature corresponds to one task executed by the farmer. On the other hand, in this embodiment, the task supervising module 60 generates the device trajectory signal based on the accumulated and stored location information of the electric device P in the database DB. According to a large amount of statistical results, when different tasks are executed, the electric device D would generate different device trajectory signals. In other words, one device trajectory signal corresponds to one task executed by the farmer. As shown in FIG. 5, the task supervising module 60 compares and finds out the first reference signal corresponding to the first task according to the signal feature included in the sensing signal S generated by the gravity sensor via the database DB. Also, the task supervising module 60 compares and finds out the first trajectory reference signal corresponding to the first task via the database DB according to the device trajectory signal generated based on the accumulated and stored location information of the electric device P corresponding to the first task. Thereby, the task supervising system in this embodiment helps the farmland manager to automatically supervise whether the task executed by the farmer is the assigned first task via the sensing signal generated by the gravity sensor and by the device trajectory signal generated from the accumulated and stored location information of the electric device P.

In details, in this embodiment, when the task supervising module 60 compares whether the sensing signal S is satisfied with the first reference signal corresponding to the first task and compares whether the device trajectory signal generated from the accumulated and stored location information of the electric device P is satisfied with the first trajectory reference signal corresponding to the first task, it is based on calculating and determining whether a relevance between the sensing signal S and the first reference signal is over a predetermined value and whether a relevance between the location information of the electric device P and the first trajectory reference signal is over another predetermined value. If the calculated relevance values are both under the predetermined values, the task supervising module 60 determines that the sensing signal S is satisfied with the first reference signal corresponding to the first task and that the accumulated and stored location information of the electric device P is satisfied with the first trajectory reference signal corresponding to the first task.

It should be noted that, in one embodiment, when the task executing module 30 determines that the location information of the electric device P is satisfied with the required task area P′, the task executing module 30 transmits, with a predetermined time interval but not continually, the sensing signal S generated by the sensor 50 and the location information of the electric device P generated by the location acquiring unit 40 to the database DB for storage, so as to save power for the electric device D.

In one embodiment, the task list received by the task executing module 30 of the electric device D may comprise a plurality of tasks (such as a first task and a second task). The farmer chooses the first task or the second task from the task list, and the first task or the second task corresponds to a required task area within the farmland managed by the administrator. In other words, after the farmer chooses the first task, he would get the information ingfrom the manager for executing the first task, such as fertilizing, at the required task area. Or, after the farmer chooses the second task, he would get the information from the manager for executing the first task, such as weeding, at another required task area. It should be noted that, the operation of the task supervising system regarding to the second task in the instant disclosure is the same as the operation of the above embodiments substantially, so the skilled in the art would be able to comprehend and further descriptions are therefore omitted.

It should be noted that, the task supervising system 4 in this embodiment may be applied to agriculture, fishery, livestock industry, mining, forestry or construction industry, so as to help the manager to automatic supervise whether the task executed by the worker is satisfied with the task in the assigned task list.

[Another Embodiment of the Task Supervising System]

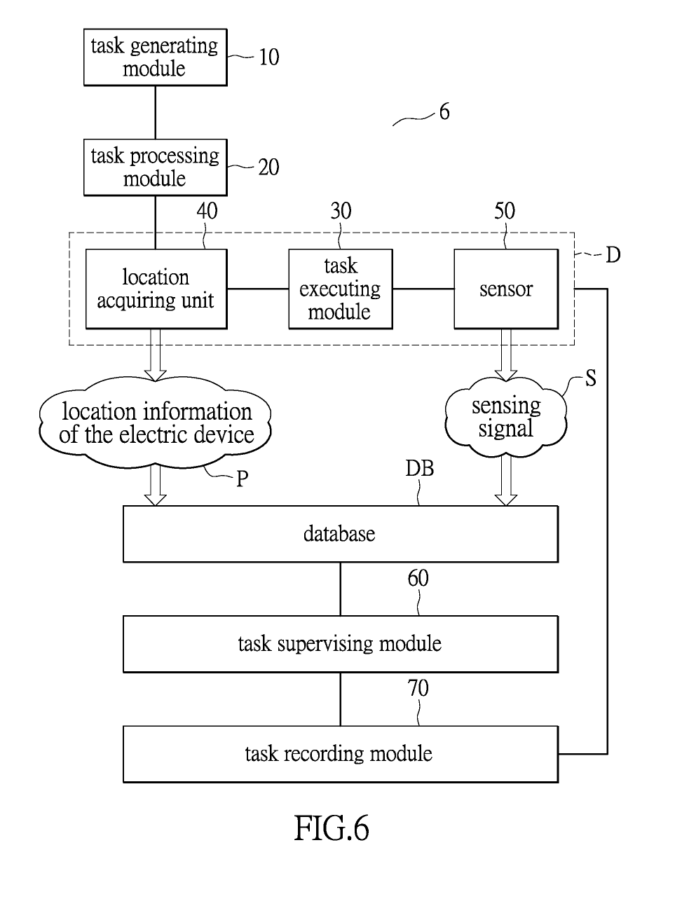

Please refer to FIG. 6, FIG. 6 shows a block diagram of a task supervising system according to another embodiment of the instant disclosure.

In the following embodiments, there are only parts different from embodiments in FIGS. 1 and 4 described, and the omitted parts are indicated to be identical to the embodiments in FIGS. 1 and 4. In addition, for an easy instruction, similar reference numbers or symbols refer to elements alike.

Different from the embodiments in FIGS. 1 and 4, the task supervising system 6 shown in FIG. 6 further comprises a task recording module 70. In this embodiment, when the task supervising module 60 compares and determines that the sensing signal S is satisfied with the first reference signal corresponding to the first task, and compares and determines that the device trajectory signal generated from the accumulated location information of the electric device P is satisfied with the first trajectory reference signal corresponding to the first task, a supervised result would be generated and would show that the first task is fulfilled. As a result, the task supervising module 60 transmits the supervised result to the task recording module 70. On the other hand, when the task supervising module 60 compares and determines that the sensing signal is not satisfied with the first reference signal corresponding to the first task, or compares and determines that the device trajectory signal generated from the accumulated location information of the electric device P is not satisfied with the first trajectory reference signal corresponding to the first task, a supervised result would be generated and would show that the first task is not fulfilled. As a result, the task supervising module 60 transmits the supervised result both to the task recording module 70 and the electric device D.

[One Embodiment of the Task Supervising Method]

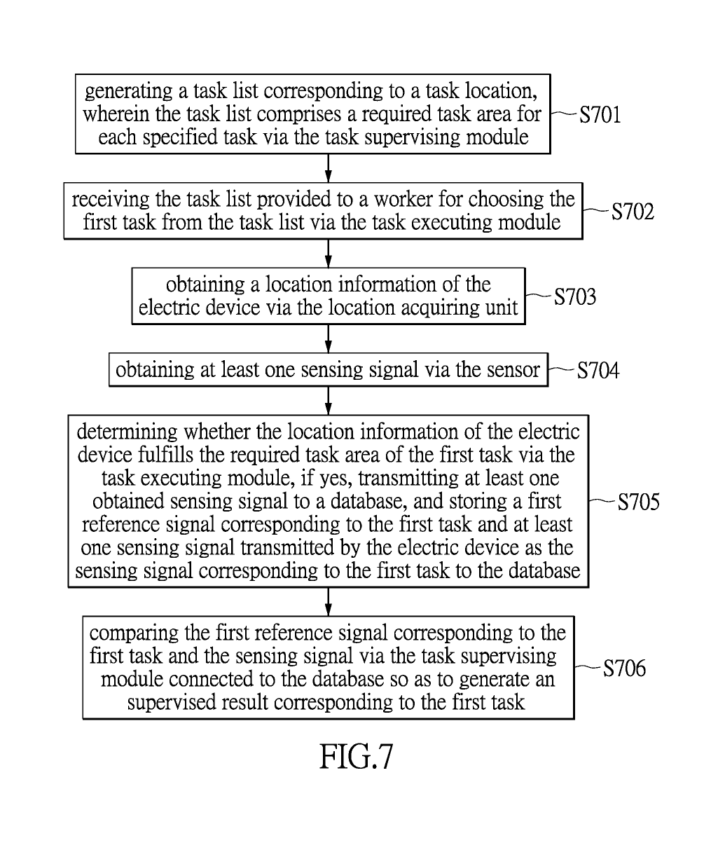

Please refer to FIG. 7, FIG. 7 shows a flow chart of a task supervising method according to an embodiment of the instant disclosure. Explanatory steps of the present embodiment may be embodied with the task supervising system 1 in FIG. 1, and thus FIG. 1 is referred for an easy instruction and better understanding.

The task supervising method used to automatically report whether a task is fulfilled comprises steps as follows: generating a task list corresponding to a task location, wherein the task list comprises a required task area for each specified task via the task supervising module 10 (Step S701); receiving the task list provided to a worker for choosing a task from the task list via the task executing module 30, such as a first task (Step S702); obtaining a location information of the electric device P via the location acquiring unit 40 (Step S703); obtaining at least one sensing signal S via the sensor 50 (Step S704); determining whether the location information of the electric device P is satisfied with the required task area of the first task via the task executing module 30, if yes, transmitting at least one obtained sensing signal S to a database DB, and storing a first reference signal corresponding to the first task and at least one sensing signal S transmitted by the electric device D corresponding to the first task to the database DB (Step S705); and comparing the sensing signal S and the first reference signal corresponding to the first task via the task supervising module 60 connected to the database DB so as to generate an supervised result corresponding to the first task (Step S706).

Relevant details of the steps of the signal demodulation method regarding the signal demodulation module are described in the embodiments of FIGS. 1, 2 and 3, and thus it is not repeated thereto. It is clarified that, a sequence of steps in FIG. 7 is set for a need to instruct easily, and thus the sequence of the steps is not used as a condition in demonstrating the embodiments of the instant disclosure.

[Another Embodiment of the Task Supervising Method]

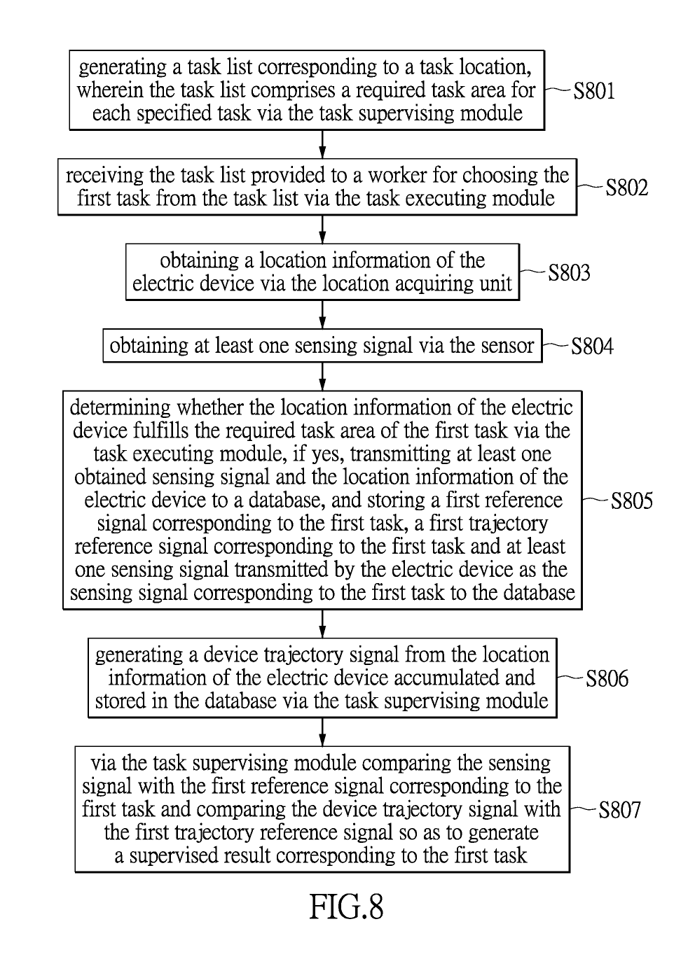

Please refer to FIG. 8, FIG. 8 shows a flow chart of a task supervising method according to another embodiment of the instant disclosure. Explanatory steps of the present embodiment may be embodied with the task supervising system 4 in FIG. 4, and thus FIG. 4 is referred for an easy instruction and better understanding.

The task supervising method used to automatically report whether a task is fulfilled comprises steps as follows: generating a task list corresponding to a task location, wherein the task list comprises a required task area for each specified task via the task supervising module 10 (Step S801); receiving the task list provided to a worker for choosing a task from the task list via the task executing module 30, such as a first task (Step S802); obtaining a location information of the electric device P via the location acquiring unit 40 (Step S803); obtaining at least one sensing signal S via the sensor 50 (Step S804); determining whether the location information of the electric device P is satisfied with the required task area of the first task via the task executing module 30, if yes, transmitting at least one obtained sensing signal S and the location information of the electric device P to a database DB, and storing a first reference signal corresponding to the first task, a first trajectory reference signal corresponding to the first task and at least one sensing signal transmitted by the electric device D corresponding to the first task to the database DB (Step S805); generating a device trajectory signal by the location information of the electric device P accumulated and stored in the database DB via the task supervising module 60 (Step S806); and via the task supervising module 60, comparing the sensing signal S with the first reference signal corresponding to the first task and comparing the device trajectory signal with the first trajectory reference signal so as to generate a supervised result corresponding to the first task (Step S807).

Relevant details of the steps of the signal demodulation method regarding the signal demodulation module are described in the embodiments of FIGS. 4 and 5, and thus it is not repeated thereto. It is clarified that, a sequence of steps in FIG. 8 is set for a need to instruct easily, and thus the sequence of the steps is not used as a condition in demonstrating the embodiments of the instant disclosure.

[Another Embodiment of the Task Supervising Method]

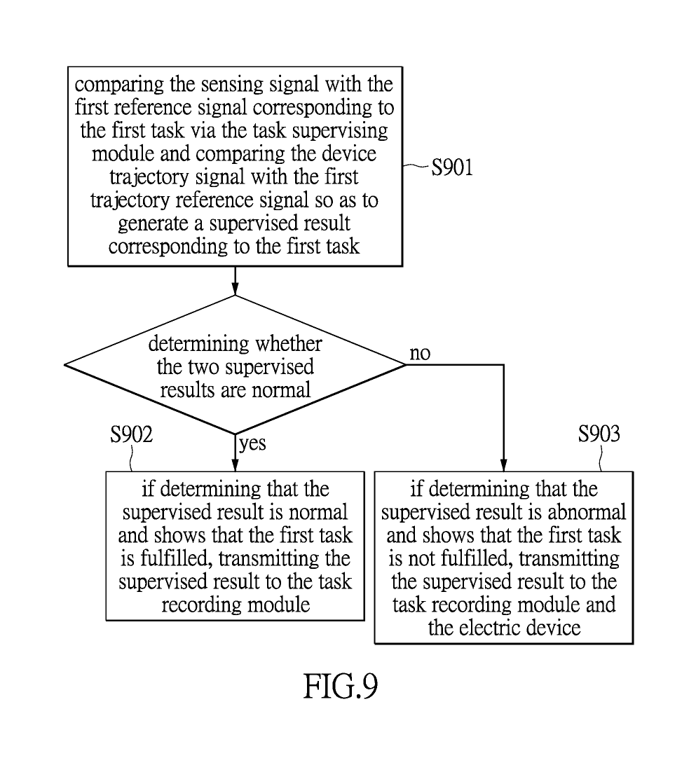

Please refer to FIG. 9, FIG. 9 shows a flow chart of a task supervising method according to an embodiment of the instant disclosure. Explanatory steps of the present embodiment may be embodied with the task supervising system 6 in FIG. 6, and thus FIG. 6 is referred for an easy instruction and better understanding.

In the following embodiments, there are only parts different from embodiments in FIGS. 7-8 described, and the omitted parts are indicated to be identical to the embodiments in FIGS. 7-8. In addition, for an easy instruction, similar reference numbers or symbols refer to elements alike.

Different from the task supervising method used to automatically report whether a task is fulfilled in the embodiments shown in the FIGS. 7-8, after the step that comparing the sensing signal S with the first reference signal corresponding to the first task and comparing the device trajectory signal with the first trajectory reference signal via the task supervising module 60 so as to generate a supervised result corresponding to the first task (Step S901), it further comprises steps as follows: if determining that the supervised result is normal and shows that the first task is fulfilled (that is, the sensing signal is satisfied with the first reference signal corresponding to the first task, and the device trajectory signal is satisfied with the first trajectory reference signal), transmitting the supervised result to the task recording module 70 (Step S902); and if determining that the supervised result is abnormal and shows that the first task is not fulfilled (that is, the sensing signal S is not satisfied with the first reference signal corresponding to the first task, or the device trajectory signal is not satisfied with the first trajectory reference signal), transmitting the supervised result to the task recording module 70 and the electric device D (Step S903).

Relevant details of the steps of the signal demodulation method regarding the signal demodulation module are described in the embodiments of FIG. 6, and thus it is not repeated thereto. It is clarified that, a sequence of steps in FIG. 9 is set for a need to instruct easily, and thus the sequence of the steps is not used as a condition in demonstrating the embodiments of the instant disclosure.

To sum up, via the task supervising system and the method thereof provided by the instant disclosure, tasks are generated by an administrator and the location information of the electric device and sensing signals are generated by a worker. After that, the location information of the electric device and the required task area are compared, and the sensing signals and the reference signals in the database are further compared, so as to generate a supervised result. Thereby, it becomes convenient for the administrator to supervise whether the worker actually fulfills tasks according to the given instructions and also to see whether the worker acts as expected.

The descriptions illustrated supra set forth simply the embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A task supervising system, used to automatically report whether a task is fulfilled, comprising:
a task supervising module, generating a task list corresponding to a task location, wherein the task list comprises a required task area for each specified task;
a task processing module, transmitting the task list to an electric device, wherein the electric device has a task executing module to receive the task list provided to a worker for choosing the first task from the task list, a location acquiring unit to obtain a location information of the electric device, and at least one sensor to obtain at least one sensing signal, and wherein the task executing module further determines whether the location information of the electric device fulfills the required task area of the first task, if yes, at least one obtained sensing signal is transmitted to a database and the database stores a first reference signal corresponding to the first task and at least one sensing signal transmitted by the electric device as the sensing signal corresponding to the first task; and
a task supervising module, connected to the database, comparing the first reference signal corresponding to the first task and the sensing signal so as to generate a supervised result corresponding to the first task.

2. The task supervising system according to claim 1, wherein the task list further comprises a second task, the task executing module of the electric device further determines whether the location information of the electric device fulfills the required task area of the second task, if yes, at least one obtained sensing signal is transmitted to the database, the database further stores a second reference signal corresponding to the second task and at least one sensing signal transmitted by the electric device as the sensing signal corresponding to the second task, and the task supervising module further compares the second reference signal corresponding to the second task and the sensing signal so as to generate an supervised result corresponding to the second task.

3. The task supervising system according to claim 1, wherein the task executing module further transmits the location information of the electric device to the database when determining the location information of the electric device fulfills the required task area of the first task, the database further records a first reference signal corresponding to the first task and the location information of the electric device transmitted by the electric device as the location information of the electric device corresponding to the first task, and the task supervising module further generates a device trajectory signal from the location information of the electric device of the first task stored in the database and compares the first task and the first trajectory reference signal so as to generate an supervised result corresponding to the first task.

4. The task supervising system according to claim 1, wherein the task executing module generates an updated required task area of the first task by adding a soft margin to the required task area of the first task before the task executing module determines whether the location information of the electric device fulfills the required task area of the first task.

5. The task supervising system according to claim 1, further comprising a task recording module, when the task supervising module compares the first reference signal corresponding to the first task and the sensing signal, the generated supervised result shows the first task being fulfilled and is transmitted to the task recording module if the task supervising module compares and determines the first reference signal corresponding to the first task and the sensing signal are satisfied, and the generated supervised result shows the first task not being fulfilled and is transmitted to the task recording module and the electric device if the task supervising module compares and determines the first reference signal corresponding to the first task and the sensing signal are not satisfied.

6. The task supervising system according to claim 1, wherein the sensor is a gravity sensor.

7. The task supervising system according to claim 1, wherein the location acquiring unit is a Global Positioning System sensor (GPS) positioning device.

8. The task supervising system according to claim 5, wherein the task supervising module calculates whether a relevance between the first reference signal corresponding to the first task and the sensing signal is over a predetermined threshold value, and the task supervising module determines that the first reference signal corresponding to the first task and the sensing signal are satisfied if the relevance is under the predetermined threshold value.

9. The task supervising system according to claim 1, wherein the task supervising system is applied to agriculture, fishery, livestock industry, mining, forestry or construction industry.

10. A task supervising method, used to automatically report whether a task is fulfilled via a task supervising system, the task supervising system comprising a task supervising system, a task processing module and a task supervising module, the task processing module transmitting the task list to an electric device, the electric device having a task executing module, a location acquiring unit and at least one sensor, the task supervising method comprising:
generating a task list corresponding to a task location, wherein the task list comprises a required task area for each specified task via the task supervising module;
receiving the task list provided to a worker for choosing the first task from the task list via the task executing module;
obtaining a location information of the electric device via the location acquiring unit;
obtaining at least one sensing signal via the sensor;
determining whether the location information of the electric device fulfills the required task area of the first task via the task executing module, if yes, transmitting at least one obtained sensing signal to a database, and storing a first reference signal corresponding to the first task and at least one sensing signal transmitted by the electric device as the sensing signal corresponding to the first task to the database; and
comparing the first reference signal corresponding to the first task and the sensing signal via the task supervising module connected to the database so as to generate an supervised result corresponding to the first task.

11. The task supervising method according to claim 10, wherein the task list further comprises a second task, the task executing module of the electric device further determines whether the location information of the electric device fulfills the required task area of the second task, if yes, at least one obtained sensing signal is transmitted to the database, the database further stores a second reference signal corresponding to the second task and at least one sensing signal transmitted by the electric device as the sensing signal corresponding to the second task, and the task supervising module further compares the second reference signal corresponding to the second task and the sensing signal so as to generate an supervised result corresponding to the second task.

12. The task supervising method according to claim 10, wherein the task executing module further transmits the location information of the electric device to the database when determining that the location information of the electric device fulfills the required task area of the first task, the database further records a first reference signal corresponding to the first task and the location information of the electric device transmitted by the electric device as the location information of the electric device corresponding to the first task, and the task supervising module further generates a device trajectory signal from the location information of the electric device of the first task stored in the database and compares the first task and the first trajectory reference signal so as to generate an supervised result corresponding to the first task.

13. The task supervising method according to claim 10, wherein the task executing module generates an updated required task area of the first task by adding a soft margin to the required task area of the first task before the task executing module determines whether the location information of the electric device fulfills the required task area of the first task.

14. The task supervising method according to claim 10, wherein the task supervising system further comprises a task recording module, when the task supervising module compares the first reference signal corresponding to the first task and the sensing signal, the generated supervised result shows the first task being fulfilled and is transmitted to the task recording module if the task supervising module compares and determines the first reference signal corresponding to the first task and the sensing signal are satisfied, and the generated supervised result shows the first task not being fulfilled and is transmitted to the task recording module and the electric device if the task supervising module compares and determines the first reference signal corresponding to the first task and the sensing signal are not satisfied.

15. The task supervising method according to claim 10, wherein the sensor is a gravity sensor.

16. The task supervising method according to claim 10, wherein the location acquiring unit is a Global Positioning System sensor (GPS) positioning device.

17. The task supervising method according to claim 14, wherein the task supervising module calculates whether a relevance between the first reference signal corresponding to the first task and the sensing signal is over a predetermined threshold value, and the task supervising module determines that the first reference signal corresponding to the first task and the sensing signal are satisfied if the relevance is under the predetermined threshold value.

18. The task supervising method according to claim 10, wherein the task supervising system is applied to agriculture, fishery, livestock industry, mining, forestry or construction industry.
